(19) United States
(12) Patent Application Publication
(10) Pub. No.: US 2009/0316899 A1
(43) Pub. Date: Dec. 24, 2009

(54) ENCRYPTION/DECRYPTION DEVICE AND SECURITY STORAGE DEVICE

(75) Inventors: Ji Soo Kim, Yongin-si (KR); Bum Seok Yu, Suwon-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 12/475,642

(22) Filed: Jun. 1, 2009

(30) Foreign Application Priority Data
Jun. 19, 2008 (KR) 10-2008-0057585

(51) Int. Cl. H04K 1/00; H04L 9/06

(52) U.S. Cl. 380/255; 380/29

(57) ABSTRACT

Provided are an encryption/decryption device and a security storage device including same. The encryption/decryption device includes a first enc/decrypter, a second enc/decrypter, a controller configured to provide a plurality of control signals in response to a setting signal, and a path selection circuit configured to connect the first enc/decrypter and the second enc/decrypter in either a series arrangement or a parallel arrangement in response to a first control signal among the plurality of control signals.

### PRIORITY STATEMENT

This U.S. non-provisional patent application claims priority under 35 U.S.C. § 119 to Korean Patent Application No. 10-2008-0057585 filed on Jun. 19, 2008, the subject matter of which is hereby incorporated by reference.

### BACKGROUND

The inventive concept relates to an encryption/decryption device and a security storage device including the encryption/decryption device.

As the use of broadband communication networks has become more common and the amount of Internet-communicated data has increased, an increasing amount of this data requires some form of privacy or security protection. Appropriate data security ensures that third parties to a data communication cannot access or destroy the constituent data. A wide variety of data security measures, including data encryption/decryption algorithms have been developed. In fact, it has become common for even relatively routine data to be securely stored in an array of so-called “security storage devices” that provide secure data generation, storage and retrieval.

The broad class of security storage devices includes, for example, hard disk drives (HDDs) and solid state drives (SSDs), including an encryption engine capable of encrypting received data before storage and decrypting data during retrieval. For example, some conventional security storage devices include an encryption engine capable of encrypting data at relatively high speed using one or more of the conventional data encryption standard (DES), triple-data encryption standard (T-DES), and advanced encryption standard (AES).

However, when data communication is performed using a high speed interface such as serial advanced technology attachment (SATA) or serial attached SCSI (SAS), the data processing speed for the encryption engine is markedly slower than the speed of data input. Thus, the data encryption process lags data input and slows the overall rate at which data may be written to the security storage device.

Data encryption lag is particularly notable for certain type of relative-data encryption methods such as the conventionally understood cipher block chaining (CBC) mode. Such encryption methods provide excellent data security, but use an encryption value derived from a previous data block when encrypting a current data block. Thus, CBC encryption and the like must proceed data block by data block, causing considerable delay in data storage.

Additionally, it is increasingly common for previously encrypted data to be stored (written to) a security storage device. In such circumstances, the already encrypted data must conventionally be applied to the constituent encryption engine, decrypted by the encryption engine, temporarily stored in a memory, and then re-encrypted by the encryption engine. This is a very time consuming process which limits the data processing speed of the security storage device.

Finally, many conventional encryption engines will only operate in a certain predetermined “set state.” As a result, it is often difficult to smoothly fit operation of the encryption engine into a stream of operating sequences outside the set state.

### SUMMARY

The inventive concept provides an encryption/decryption device incorporating a plurality of enc/decrypter circuits that may be combined in their operation to provide flexible and efficient encryption and/or decryption capabilities relative to the data input and/or output of a security storage device.

According to an aspect of the inventive concept, an encryption/decryption device comprises; a first enc/decrypter, a second enc/decrypter, a controller configured to provide a plurality of control signals in response to a setting signal, and a path selection circuit configured to connect the first enc/decrypter and the second enc/decrypter in either a series arrangement or a parallel arrangement in response to a first control signal among the plurality of control signals.

According to another aspect of the inventive concept, a security storage device comprises; an encryption/decryption device, and a data storage device configured to receive encrypted data from the encryption/decryption device and providing stored data to the encryption/decryption device for decryption, wherein the enc/decryption device comprises; a first enc/decrypter, a second enc/decrypter, a controller configured to provide a plurality of control signals in response to a setting signal, and a path selection circuit configured to connect the first enc/decrypter and the second enc/decrypter in either a series arrangement or a parallel arrangement in response to a first control signal among the plurality of control signals.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of an encryption/decryption device including a plurality of enc/decrypter circuits according to an embodiment of the present inventive concept;

FIG. 2 is a block diagram further illustrating a parallel connection for the plurality of enc/decrypter circuits according to an embodiment of the present inventive concept;

FIG. 3 is a block diagram further illustrating a serial connection for the plurality of enc/decrypter circuits according to an embodiment of the present inventive concept; and

FIG. 4 is a block diagram of a host system incorporating a security storage device according to an exemplary embodiment of the present inventive concept.

### DESCRIPTION OF THE EMBODIMENTS

Several embodiments of the inventive concept will now be described with reference to the accompanying drawings. However, the present inventive concept may be variously embodied and should not be construed as being limited to only the illustrated embodiments. Rather, the illustrated embodiments are presented as teaching examples. Throughout the drawings and written description, like references are used to denote like or similar elements.

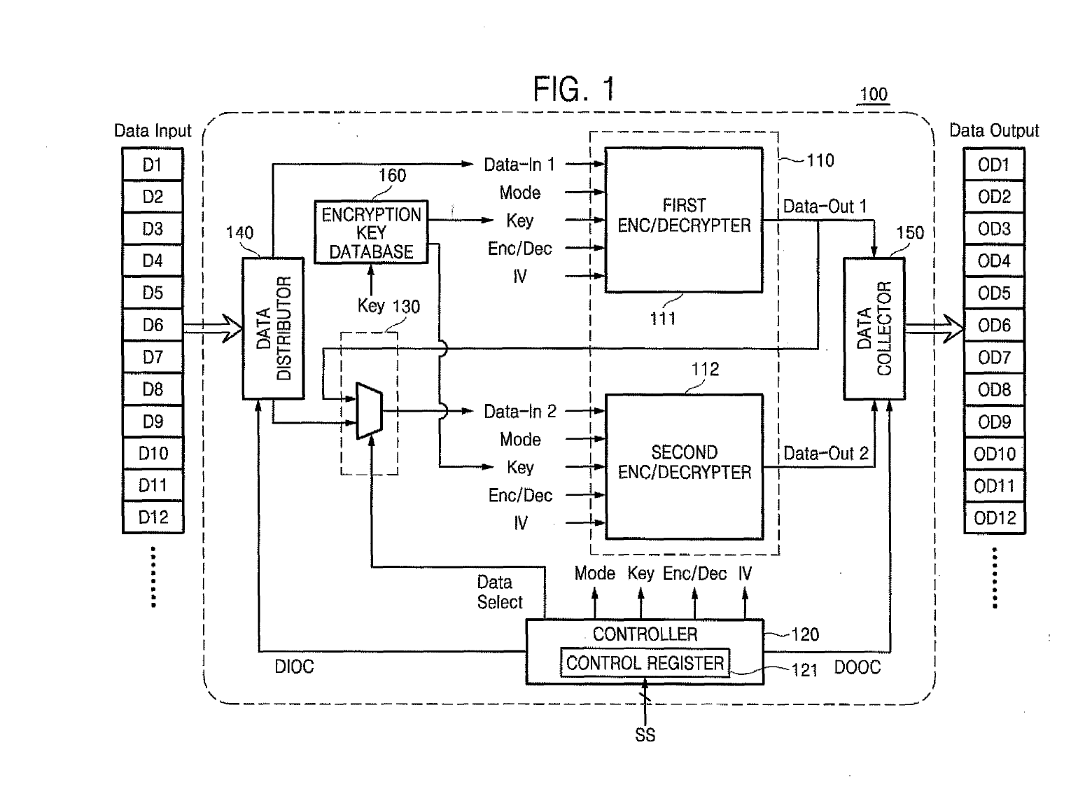

FIG. 1 is a block diagram of an encryption/decryption device 100 incorporating a plurality of encryption and/or decryption circuits (hereafter, indicated as “enc/decrypter circuits”). The specific hardware, firmware and/or software implementation of the enc/decrypter circuits is a matter of design choice. Separate encryption and decryption circuits may be implemented and collectively operated to provide the desired enc/decrypter circuit functionality, or a single integrated circuit (IC) may be configured to provide such functionality.

Referring to FIG. 1, the encryption/decryption device 100 may be thought of as a secure data engine. In the illustrated example, the encryption/decryption device 100 generally comprises an encryption/decryption unit 110, a controller 120, a connection path selection circuit 130, a data distributor 140, a data collector 150, or an encryption key database 160.

In the illustrated example of FIG. 1, the encryption/decryption unit 110 is capable of encrypting and/or decrypting received input data (Data-In) and comprises a first enc/decrypter 111 and a second enc/decrypter 112. The input data to be encrypted or decrypted may take the form of a stream of data received from a host interface, for example. The input data will be sequentially received in response to host device command and control, but may be stored in a buffer memory (e.g., a RAM) upon receipt. As is common with most security storage devices, the plurality of enc/decrypters 111 and 112 receive and operate upon input data having one or more defined block sizes. In the working embodiment of FIG. 1, a 16 bit data block size is assumed for purposes of illustration.

The first and second enc/decrypters 111 and 112 perform encryption and/or decryption operations in response to an enc/decryption control signal (Enc/Dec) received from the controller 120. That is, in response to the enc/decryption control signal, both of the first enc/decrypter 111 and the second enc/decrypter 112 may perform encryption, both of the first enc/decrypter 111 and the second enc/decrypter 112 may perform decryption, or the first enc/decrypter 111 and the second enc/decrypter 112 may perform different operations.

The controller 120 also provides a data select signal (Data Select) in accordance with a setting signal (SS) received from the host device and applied (e.g.,) to a control register 121 internal to the controller 120. The setting signal will generally include control information defining a connection (or configuration) relationship between the first enc/decrypter 111 and the second enc/decrypter 112. The setting signal may also include information regarding a current mode of operation, an imported encryption key, an initialization vector, and/or other externally provided enc/decryption information. For example, the setting signal may include information regarding the length of a particular encryption key (e.g., 128 bits or 256 bits), and/or the number and type of enc/decrypters to be used during a particular encryption and/or decryption operation.

In the illustrated example of FIG. 1, the controller 120 also provides a data input control signal (DIOC) in response to the setting signal received from the host device. The data input control signal is applied to the data distributor 140 which directs input data to one or both of the first enc/decrypter 111 and second enc/decrypter 112. The input data provided to second enc/decrypter 112 passes through the path selection circuit 130. In the illustrated example, the path selection circuit 130 is implemented as a simple multiplexer.

When the input data is provided to both of the first enc/decrypter 111 and the second enc/decrypter 112, the data distributor 140 may cause the stream of input data to be divided (e.g., first input data (Data-In 1) and second input data (Data-In 2)) in a defined manner between the two (2) enc/decrypters. Such input data division will generally be performed in relation to a defined unit data block.

In the illustrated example of FIG. 1, the first input data is passed directly to the first enc/decrypter 111 from data distributor 140, while the second input data is passed to the second enc/decrypter 112 via the path selection circuit 130. Using the simple input data definition shown in FIG. 1, the first input data provided to first enc/decrypter 111 may include odd numbered data blocks (e.g., D1, D3, D5, . . . ) while the second input data provided to second enc/decrypter 112 may include even numbered data blocks (D2, D4, D6, . . . ). Those skilled in the art will recognize the more than two enc/decrypters may be used and/or that more sophisticated input data division techniques may be used (e.g., division by data block recognition, poll & hold data provision, data temporary storage followed by output with block reconfiguration, etc.).

The path selection circuit 130 may be configured to selectively provide to the second enc/decrypter 112 either the second input data provided by data distributor 140 or the first output data (Data-Out 1) provided at the output of first enc/decrypter 111. The selection of input data to second enc/decrypter 112 by the path selection circuit 130 may be controlled by the data selection signal provided by the controller 120.

For example, within the encryption/decryption device 100 of FIG. 1, the controller 120 may select the input data applied to the second enc/decrypter 112 in accordance with recognition as to whether or not the received input data is already encrypted. Where the input data is already encrypted and must first be decrypted before being re-encrypted for storage by the security storage device, it is highly beneficial to operationally connect the first enc/decrypter 111 and the second enc/decrypter 112 in series. With this configuration, threshold input data decryption may be accomplished in the first enc/decrypter 111 using (e.g.,) a user-provided encryption key, and thereafter the resulting first output data may be applied to the second enc/decrypter 112 for re-encryption. Those skilled in the art will recognize the re-encryption may use a different encryption key or entirely different encryption protocol from that associated with the threshold input data decryption.

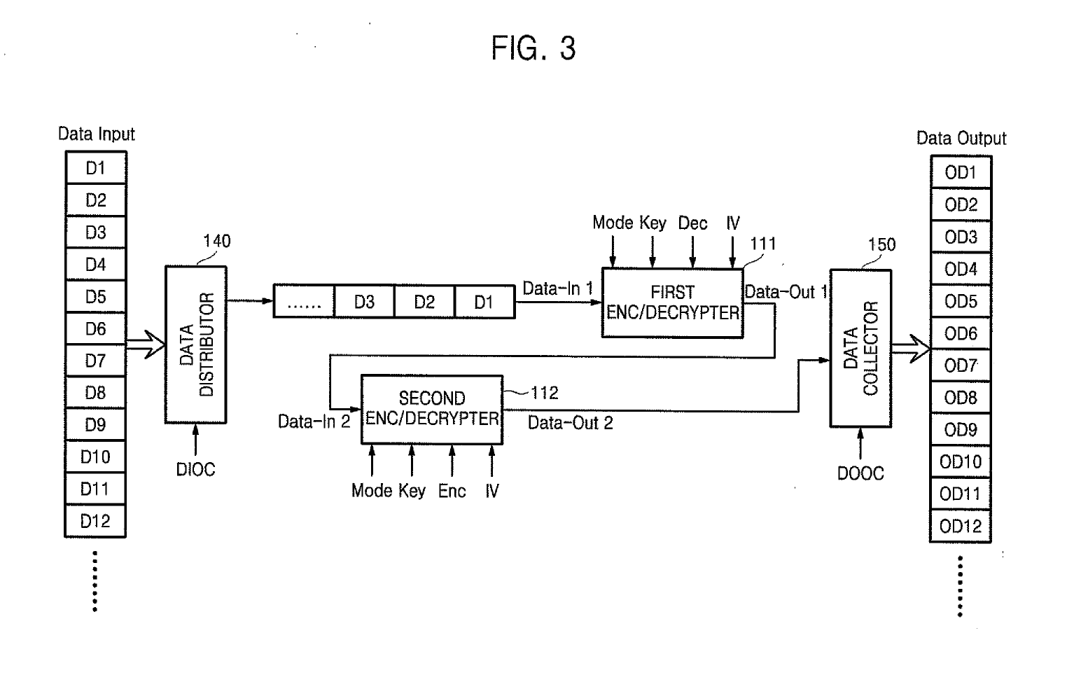

A serial connection of the first enc/decrypter 111 and the second enc/decrypter 112 is further illustrated in FIG. 3. Here, input data (D1, D2, D3 . . . ) is assumed to be already encrypted and is therefore sequentially applied data block by data block to the first enc/decrypter 111 via data distributor 140 as controlled by the data input control signal (DIOC) provided by the controller 120. Thus, first input data (Data-In 1) is applied to the first enc/decrypter 111 which decrypts it to yield first output data (Data-Out 1).

It is further assumed that decryption by the first enc/decrypter 111 is accomplished using an internally generated encryption key. Such “internal” encryption precludes external recognition of the constituent encryption key. Accordingly, control inputs to the first enc/decrypter 111, such as mode definition (Mode), encryption key (Key), a decryption operation indication (Dec), and an initialization vector control signal (IV) may be internally generated in response to user input (e.g., a password) or in response to securely provided host device information (e.g., a session key).

Following decryption of the first input data and provision of decrypted first output data by the first enc/decrypter 111, the first output data is applied via path selection circuit 130 to the input terminal of the second (serially connected) enc/decrypter 112 as second input data (Data-In 2). Hence, the threshold decrypted input data is re-encrypted using, for example, one of the encryption keys stored in the encryption key database 160. The resulting second output data (Data-Out 2) is then passed to data collector 150 where it may be temporarily buffered before being provided as output data in response to the data output control signal DOOC provided by the controller 120 for storage within (e.g.,) non-volatile memory of a SSD associated with the constituent security storage device.

In another embodiment of the inventive concept, serially connect first enc/decrypter 111 and second enc/decrypter 112 may be used to double (2×) encrypt received input data for added data security.

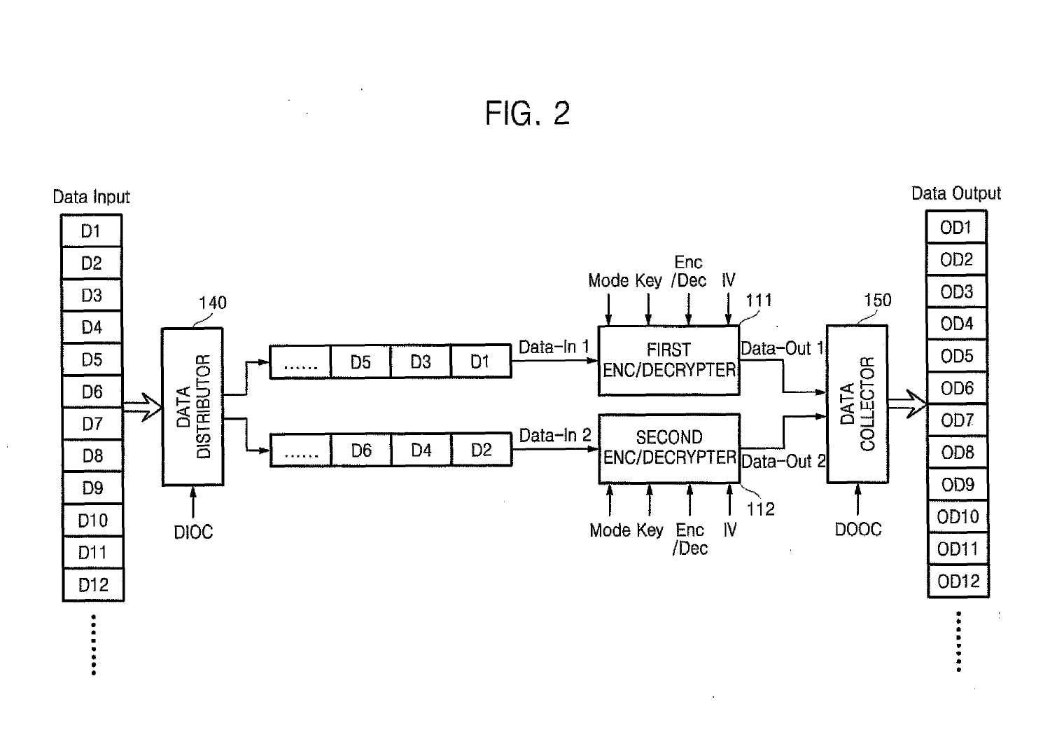

In contrast with the serial connection example illustrated in FIG. 3, a parallel connection of the first enc/decrypter 111 and second enc/decrypter 112 is illustrated in FIG. 2. In many applications, this type of parallel connection allows much improved input data throughput and storage, thereby avoiding the encryption input lag that characterizes many conventional security storage devices.

Referring collectively to FIGS. 2 and 3, the controller 120 provides the data input control signal (DIOC) to the data distributor 140 to define the transmission of input data within the encryption/decryption device 100. The data selection signal applied to the path selection circuit 130 also cooperates in this process as noted above. In relation to the embodiment illustrated in FIG. 2, the input data will be divided by the data distributor 140 into first input data (odd data blocks) and second input data (even data blocks). The first input data is then applied to the input terminal of the first enc/decrypter 111 and the second input data is applied to the input terminal of the second enc/decrypter 112.

In one or both of the foregoing exemplary embodiments, the controller 120 may further provide the operation mode control signal (Mode) for controlling an operation mode of the first enc/decrypter 111 and/or the second enc/decrypter 112 in response to the setting signal (SS). The operation mode may select between conventionally understood modes, such as (e.g.) an electronic codebook (ECB) mode, a cipher block chaining (CBC) mode, a cipher feedback (CFB) mode, an output feedback (OFB) mode, a counter (CTR) mode, etc. The operation mode selected is a matter of design choice in relation to the particular encryption/decryption method being used by one or more the enc/decrypters.

The ECB mode is a method of individually encrypting/decrypting input data on a data block by data block basis (i.e., “plain block”). Thus, the ECB mode may be very simply realized and provide high speed input data throughput. However, the ECB mode provides relatively weak data security because the so-called plain block and corresponding encryption block are maintained in a one-for-one relationship.

The CBC mode uses an encryption block that is derived from a previously encrypted plain block when encrypting a current plain block. Thus, since each encryption block is affected not only by the current plain block but also by the previous encryption blocks, the security provided by the CBC mode is stronger than that provided by the ECB mode. For example, well-known Internet security protocols (IPSec) use a CBC mode, (e.g., 3DES-CBC or AES-CBC) to enforce provide data security.

The CFB mode is a method of using a previously encrypted block as an input for the constituent encryption algorithm. The term “feedback” is used to indicate that an encryption block is used as a next operation input. In the CFB mode, the encryption block may be generated by logically XOR-ing the outputs of a plain block and an encryption algorithm.

The OFB mode is a method which also feeds-back the output of an encryption algorithm as an input of an encryption algorithm. The CTR mode is a stream encryption method of generating a key stream by encrypting a counter that increases by 1. That is, the result of the XOR operation of the plain block and a bit sequence obtained by encrypting the counter is the encryption block. The initial value of the counter may be generated based on different values for each encryption. The CTR mode may be very simply embodied by a program and may enc/decrypt blocks in an arbitrary order.

Those skilled in the art will recognize that other types of encryption/decryption may be used with embodiments of the inventive concept. Thus, the first enc/decrypter 111 and/or the second enc/decrypter 112 may be operated in any one of a number of modes in response to the operation mode control signal provided by the controller 120. The first enc/decrypter 111 and the second enc/decrypter 112 may be operated in the same operation mode or in different operation modes. Also, the controller 120 may further provide an encryption key control signal (Key) controlling an encryption key used by the first enc/decrypter 111 and/or the second enc/decrypter 112 in response to the setting signal (SS). As is understood by those skilled in the art an encryption key is needed for successful encryption and/or decryption of data and may take many different forms with the data security storage device.

As noted above the encryption/decryption device 100 may include the encryption key database 160. The encryption key database 160 may provide an encryption key to the first enc/decrypter 111 or the second enc/decrypter 112 in response to the encryption key control signal. The encryption keys used by the first enc/decrypter 111 and the second enc/decrypter 112 may be the same or different.

The controller 120 may further provide the enc/decryption control signal (Enc/Dec) selecting the basic encryption or decryption operation performed by the first enc/decrypter 111 or the second enc/decrypter 112 in response to the setting signal. Thus, the first enc/decrypter 111 or the second enc/decrypter 112 may perform either encryption or decryption in response to the enc/decryption control signal Enc/Dec. For example, both of the first enc/decrypter 111 and the second enc/decrypter 112 may perform encryption or decryption, or the first enc/decrypter 111 and the second enc/decrypter 112 may perform different operations from each other.

The controller 120 may further provide the initialization vector control signal IV controlling which initialization vector may be used by the first enc/decrypter 111 or the second enc/decrypter 112 in response to the setting signal. For example, in the CBC mode, when an initial plain block is encrypted, since a previous encrypted block does not exist, an initialization vector to be used instead is needed so that the initialization vector may be embodied by a block data of a bit sequence. The initialization vector may have the same length as that of a data block that is encrypted. Also, since the initialization vector is inserted prior to the initial plain block to perform the enc/decryption operation, the initialization vector does not affect the feature of data.

The controller 120 may further provide the data output control signal (DOOC) in response to the setting signal. The data collector 150 collects the first output data Data-Out1 from the first enc/decrypter 111 and/or the second output data Data-Out2 from the second enc/decrypter 112. The final output data may be provided in many different forms, whether aggregated, separated or variously conjoined, as between the first and second output data provided the first enc/decrypter 111 and/or the second enc/decrypter 112. For example, when both the first and second output data are collected by data collector 150, odd output data blocks (OD1, OD3, OD5, . . . ) may be separately provided from even output data blocks (OD2, OD4, OD6, . . . ). Alternately, the odd/even output data blocks may be re-aggregated to mirror input data blocks (D1, D3, D5, . . . ).

The generated output data may be stored in a memory, (e.g., a RAM) integral to the data collector 150 or otherwise disposed within the security storage device. Accordingly, the controller 120 may provide a variety of output data formats given appropriate control signals in response to the setting signal defined by the host device. Hence, the output configuration and data output, along with the encryption/decryption configuration, and the input configuration and data input of the encryption/decryption device 100 may be flexibly arranged by selective and cooperative control of the various enc/decrypters, the path selection circuit 130, the data distributor 140, the data collector 150, the encryption key database 160, etc., in response to various control signals.

Returning to FIG. 2, a parallel connection between the plurality of enc/decrypters is illustrated according to an embodiment of the inventive concept. As noted above, when the input data is not already encrypted, the first and second enc/decrypters 111 and 112 may be connected parallel and cooperatively operated to improve input data throughput. However, a parallel connection of the first and second enc/decrypters 111 and 112 may be advantageously used even when the input data is already encrypted.

Given the arrangement of FIG. 2, the data distributor 140 divides the input data into first and second input data according to even and odd data blocks, and then passes the first and second input data to the first and second enc/decrypters 111 and 112, respectively, in response to the data input control signal provide by the controller 120.

The first enc/decrypter 111 and/or the second enc/decrypter 112 may be flexibly adapted to a variety of operating environments in response to the operation mode control signal Mode, the encryption key control signal Key, the enc/decryption control signal Enc/Dec, or the initialization vector control signal IV provided by the controller 120. Following encryption/decryption the first output data (Data-Out 1) provided by the first enc/decrypter 111 and the second output data (Data-Out2) provided by the second enc/decrypter 112 are passed to the data collector 150. The data collector 150 selectively outputs the received data and generates the output data in a form consistent with its original data order in response to the data output control signal DOOC provided by the controller 120.

Because the original input data is divided into a plurality of encryption/decryption data stream, overall input data throughput is greatly increased, as compared with conventional encryption engines.

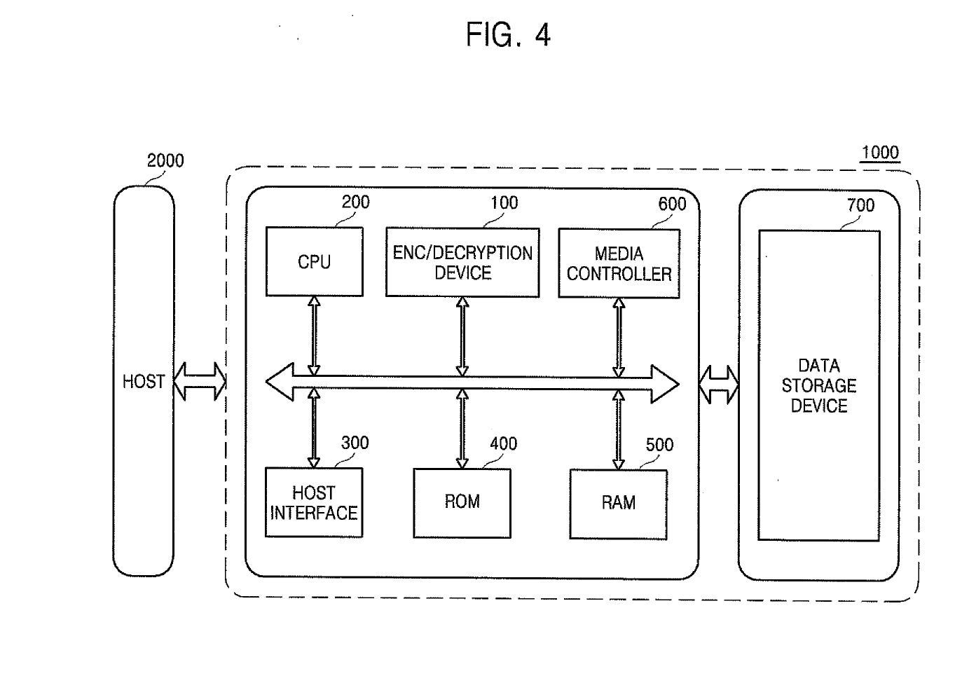

FIG. 4 is a block diagram illustrating the structure of a security storage device 1000 according to an embodiment of the inventive concept. Referring to FIG. 4, the security storage device 1000 may include an enc/decryption device 100 and a data storage device 700 storing data encrypted by the encryption/decryption device 100 or providing data to be decrypted by the encryption/decryption device 100. The encryption/decryption device 100 may include a plurality of enc/decrypters arranged in series or in parallel.

Also, the security storage device 1000 may further include a central processing unit (CPU) 200 controlling respective elements or performing data calculation or processing, a media controller 600 reading or writing data to fit to the physical properties of the data storage device 700, a host interface 300 performing interface protocol, for example, parallel advanced technology attachment (PATA) or serial advanced technology attachment (SATA), to exchange data with a host 2000, a read only memory (ROM) 400 storing codes needed for performing an operation, or a read access memory (RAM) 500 storing data or codes needed for driving the security storage device 1000.

As described above, according to the present inventive concept, a plurality of enc/decrypters may be flexibly and efficiently used to adapt to a variety of operating environments to improve input data throughput while allowing very strong data security.

While the inventive concept has been particularly shown and described with reference to exemplary embodiments thereof, it will be understood that various changes in form and details may be made therein without departing from the scope of the following claims.

What is claimed is:

1. An encryption/decryption device comprising:
a first enc/decrypter;
a second enc/decrypter;
a controller configured to provide a plurality of control signals in response to a setting signal; and
a path selection circuit configured to connect the first enc/decrypter and the second enc/decrypter in either a series arrangement or a parallel arrangement in response to a first control signal among the plurality of control signals.

2. The device of claim 1, further comprising:
a data distributor configured to distribute input data to at least one of the first enc/decrypter and the path selection circuit in response to a second control signal among the plurality of control signals.

3. The device of claim 1, further comprising:
a data collector configured to collect output data provided by at least one of the first enc/decrypter and the second enc/decrypter in response to a third control signal among the plurality of control signals.

4. The device of claim 2, wherein the data distributor distributes the input data as first input data to the first enc/decrypter and second input data to the second enc/decrypter, wherein the second input data is distributed to the second enc/decrypter via the path selection circuit.

5. The device of claim 4, wherein the first enc/decrypter and the second enc/decrypter are arranged in parallel to cooperatively encrypt/decrypt the input data provided as first and second input data respectively.

6. The device of claim 4, wherein the first input data comprises odd data blocks of the input data and the second input data comprises even data blocks of the input data.

7. The device of claim 2, wherein the data distributor distributes the input data to only the first enc/decrypter and the first and second enc/decrypters are arranged in series, such that the path selection circuit selectively outputs first data output provided by the first enc/decrypter as input data to the second enc/decrypter in response to the first control signal.

8. The device of claim 7, wherein the input data has already been encrypted using a first encryption operation; and
the first enc/decrypter is configured to decrypt the already encrypted input data to generate the first output data, and the second enc/decrypter is configured to encrypt the first output data using a second encryption operation.

9. The device of claim 8, wherein the first and second encryption operations are the same.

10. The device of claim 1, wherein at least one of the first enc/decrypter and second enc/decrypter is operated in an electronic codebook (ECB) mode, a cipher block chaining (CBC) mode, a cipher feedback (CFB) mode, an output feedback (OFB) mode, or a counter (CTR) mode in response to a fourth control signal among the plurality of control signals.

11. The device of claim 1, further comprising:
an encryption key database configured to store an encryption key used for an encryption/decryption operation performed by at least one the first enc/decrypter and second enc/decrypter,
wherein the encryption key is provided from the encryption key database to the at least one of the first enc/decrypter and second enc/decrypter in response to a fifth control signal among the plurality of control signals.

12. A security storage device comprising:
an encryption/decryption device; and
a data storage device configured to receive encrypted data from the encryption/decryption device and providing stored data to the encryption/decryption device for decryption, wherein the enc/decryption device comprises:
a first enc/decrypter;
a second enc/decrypter;
a controller configured to provide a plurality of control signals in response to a setting signal; and
a path selection circuit configured to connect the first enc/decrypter and the second enc/decrypter in either a series arrangement or a parallel arrangement in response to a first control signal among the plurality of control signals.

13. The security storage device of claim 12, wherein the security storage device is implemented as a hard disk drive (HDD), a solid state drive (SSD), a flash memory card, or a smart card.

14. The security storage device of claim 13, further comprising:
a data distributor configured to distribute input data to at least one of the first enc/decrypter and the path selection circuit in response to a second control signal among the plurality of control signals.

15. The security storage device of claim 13, further comprising:
a data collector configured to collect output data provided by at least one of the first enc/decrypter and the second enc/decrypter in response to a third control signal among the plurality of control signals.

16. The security storage device of claim 14, wherein the data distributor distributes the input data as first input data to the first enc/decrypter and second input data to the second enc/decrypter, wherein the second input data is distributed to the second enc/decrypter via the path selection circuit.

17. The security storage device of claim 16, wherein the first enc/decrypter and the second enc/decrypter are arranged in parallel to cooperatively encrypt/decrypt the input data provided as first and second input data respectively.

18. The security storage device of claim 16, wherein the first input data comprises odd data blocks of the input data and the second input data comprises even data blocks of the input data.

19. The security storage device of claim 14, wherein the data distributor distributes the input data to only the first enc/decrypter and the first and second enc/decrypters are arranged in series, such that the path selection circuit selectively outputs first data output provided by the first enc/decrypter as input data to the second enc/decrypter in response to the first control signal.

20. The security storage device claim 19, wherein the input data has already been encrypted using a first encryption operation; and
the first enc/decrypter is configured to decrypt the already encrypted input data to generate the first output data, and the second enc/decrypter is configured to encrypt the first output data using a second encryption operation.
